(19) United States
(12) Patent Application Publication
(10) Pub. No.: US 2021/0278817 A1
(43) Pub. Date: Sep. 9, 2021

(54) ONLINE PRECISE CONTROL METHOD FOR TRUNCATING PARAMETERS OF MICROSCALE ABRASIVE GRAINS

(71) Applicant: SOUTH CHINA UNIVERSITY OF TECHNOLOGY, Guangdong (CN)

(72) Inventors: Jin XIE, Guangdong (CN); Quanpeng HE, Guangdong (CN); Hao YANG, Guangdong (CN); Jiaming LEI, Guangdong (CN)

(73) Assignee: SOUTH CHINA UNIVERSITY OF TECHNOLOGY, Guangdong (CN)

(21) Appl. No.: 17/048,105

(22) PCT Filed: Aug. 14, 2019
(86) PCT No.: PCT/CN2019/100472

§ 371 Date: Oct. 16, 2020

(30) Foreign Application Priority Data
Jun. 22, 2018 (CN) 201810647229.2

(51) Int. Cl. G05B 19/18; G05B 19/406; G05B 19/416; B24B 53/00; B24B 53/08

(52) U.S. Cl. CPC G05B 19/182; G05B 19/406; B24B 53/08; B24B 53/001; G05B 19/4163

(57) ABSTRACT

An online precise control method for truncating parameters of microscale abrasive grains includes the steps of: (1) clamping an electrode and a diamond grinding wheel to form a discharge circuit, and communicating a workstation with a power supply and a controller of a numerical control machine tool; (2) feedback controlling movement parameters of the machine tool and parameters of the power supply according to pulse discharge parameters, controlling a discharge current and a discharge voltage, and calculating a number of rotations of the grinding wheel; (3) determining a maximum truncating area of a cutting edge and a maximum effective number of rotations of the grinding wheel according to grinding wheel parameters and pulse discharge parameters, and precisely controlling a truncating area of a cutting edge of abrasive grains online by the calculated number of rotations of the grinding wheel; and (4) after the calculated number of rotations of the grinding wheel reaches a target value, calculating a truncating area of the cutting edge and a protrusion height of truncating microscale abrasive grains, and stopping the machine tool.

### TECHNICAL FIELD

The present invention relates to the technical field of truncating microscale abrasive grains of a diamond grinding wheel, and more particularly, relates to an online precise control method for truncating parameters of microscale abrasive grains.

### DESCRIPTION OF RELATED ART

A surface quality of a workpiece in precision grinding depends on protrusion topography and a distribution status of microscale diamond abrasive grains. At present, the protrusion topography of the microscale diamond abrasive grains can be controlled by mechanical grinding, electric spark contact discharge, laser and other trimming technologies, thus solving problems of protrusion and alignment of the microscale abrasive grains. However, since extraction and analysis of the protrusion topography of the microscale diamond abrasive grains usually depend on precise detection instruments such as a scanning electron microscope and a white light interferometer. An online evaluation problem of protrusion parameters of the microscale abrasive grains has not yet been solved while trimming a grinding wheel.

In order to solve the problem, ZL201511010161.X “Online Monitoring Device of Grinding Wheel Microdischarge Sharpening and Trimming” granted on Oct. 20, 2017 discloses an online evaluation method for protrusion parameters of microscale abrasive grains of a grinding wheel that is sharpened and trimmed, wherein a principle thereof is that: a three-dimensional image of the protrusion of the microscale abrasive grains is photographed by machine vision, then a topographical feature value is extracted by image processing software and converted into digital information. Moreover, the extracted protrusion parameters are compared with reference values, and a numerical control machine tool system is used to adaptively adjust parameters of a power supply and movement parameters of a machine tool according to comparison results and pulse discharge parameters obtained in real time, so as to realize online sharpening and trimming of the microscale abrasive grains of the grinding wheel. However, the technology has the following defects.

A robot vision system is expensive, and protective measures are required during discharge trimming of the grinding wheel to prevent a CCD camera from being damaged by splashing of cutting chips and electric sparks.

There is great limitation on the detection method, and the detection can only be performed when the grinding wheel is stationary. Moreover, a detection effect is affected by a size of the abrasive grain, so that it is difficult to monitor truncating parameters of the microscale abrasive grains in real time.

Topography of the microscale abrasive grains collected by the CCD camera is all two-dimensional images, and light transmission of the microscale abrasive grains is easy to generate image distortion. These factors may all affect subsequent data processing, resulting in a large error in the extracted topographical feature value of the abrasive grains.

In addition, CN201710823408.2 “Method for Controlling Pulse Discharge Trimming Parameters and Movement Parameters for Truncating of Microscale Abrasive Grains of Grinding Wheel” filed on Sep. 13, 2017 discloses a method for controlling pulse discharge parameters and movement parameters of a machine tool while truncating the microscale abrasive grains, and a principle thereof is that: an protrusion height model of the abrasive grains is established according to a relationship between a discharge gap and a cutting chip raising height, and a discharge voltage is controlled in a range of 19 V to 23 V by adjusting the movement parameters of the machine tool in position, so as to realize graphitized truncating of an cutting edge of the microscale abrasive grains. Moreover, the protrusion height of the abrasive grains and an effective number of the abrasive grains of the grinding wheel can be predicted by tracing the pulse discharge parameters and the movement parameters of the machine tool, thus creating favorable conditions for intelligent truncating. However, the technology also has the following defects.

The above technology focuses on how to solve a problem of a graphitized truncating efficiency of the cutting edge of the microscale abrasive grains. Although the technology involves the online monitoring method for the pulse discharge trimming parameters and the movement parameters of the machine tool, a problem of building online monitoring system has not been solved yet.

The protrusion height of the abrasive grains and the effective number of the abrasive grains of the grinding wheel predicted can only reflect protrusion state of the microscale abrasive grains, but the truncated topographical feature thereof cannot be precisely monitored online.

The protrusion height of the abrasive grains and the effective number of the abrasive grains of the grinding wheel are only used as indicators to measure a truncating effect of the microscale abrasive grains during truncating, an application value of the truncated topography thereof cannot be reflected during practical machining, especially for coarse diamond abrasive grains. Moreover, it is difficult to meet control requirements on a truncating time.

### SUMMARY

### Technical Problems

### Solution of the Problems

### Technical Solution

An objective of the present invention is to overcome the defects in the prior art, and provide an online precise control method for truncating parameters of microscale abrasive grains. According to the method, a robot vision technology does not need to be used, a workstation only needs to be communicated with a controller and a power supply of a numerical control machine tool during truncating. A truncating effect of microscale abrasive grains may be precisely controlled online through a number of rotations of a grinding wheel, pulse discharge parameters and movement parameters of a machine tool fed back by a system. A working principle thereof is that: a cutting edge of raised microscale abrasive grains on a working surface of a grinding wheel contacts with an electrode once every rotation during trimming, and then is gradually truncated under a combined action (i.e., a mechanical thermochemical effect) of a grinding force, grinding heat and an instantaneous high temperature of electric spark discharge. A removal amount thereof is related to a size of the abrasive grains, the pulse discharge parameters and the movement parameters of the machine tool. A truncating area of the cutting edge of the abrasive grains may be precisely controlled online by adjusting the number of rotations of the grinding wheel by using a similarity before and after truncating the microscale abrasive grains.

The technical solution used in the present invention to solve the above technical problem is as follows.

An online precise control method for truncating parameters of microscale abrasive grains includes the following steps:

\textcircled{1} clamping an electrode and a diamond grinding wheel to be truncated on a numerical control machine tool, connecting the diamond grinding wheel (+), the electrode (−), a power supply, a voltage sensor, a current sensor and a data collection card in a positive electrode manner to form a discharge circuit, and communicating a workstation with the power supply and a controller of the numerical control machine tool;

\textcircled{2} during in-position truncating, setting grinding wheel parameters and a target value of a number of rotations of the grinding wheel and planning a grinding wheel path, respectively feedback controlling movement parameters of the machine tool and parameters of the power supply through machine tool-PC online monitoring software and power supply-PC online monitoring software according to collected pulse discharge parameters, controlling a discharge current and a discharge voltage in a range of 3 A to 6 A and in a range that is 2 V to 5 V lower than an open circuit voltage of the power supply respectively, and calculating the number of rotations of the grinding wheel by the movement parameters of the machine tool;

\textcircled{3} selecting a maximum truncating area of a cutting edge and a maximum effective number of rotations of the grinding wheel thereof under the corresponding grinding wheel parameters, the corresponding pulse discharge parameters and the corresponding movement parameters of the machine tool from an expert database 1, and precisely controlling a truncating area of the cutting edge of truncating microscale abrasive grains online by the calculated number of rotations of the grinding wheel; and

\textcircled{4} comparing the calculated number of rotations of the grinding wheel with a set target value, after the calculated number of rotations of the grinding wheel reaches the target value, calculating the truncating area of the cutting edge and an protrusion height of the truncating microscale abrasive grains by the number of rotations of the grinding wheel, the pulse discharge parameters and the movement parameters of the machine tool, and meanwhile, sending a stop command, by the workstation, to the machine tool-PC online monitoring software to stop the machine tool.

The truncating area of the cutting edge of the microscale abrasive grains is precisely controlled online by the number of rotations of the grinding wheel on a premise that a discharge current and a discharge voltage need to be controlled in a range of 3 A to 6 A and in a range that is 2 V to 5 V lower than an open circuit voltage of the power supply respectively, which is to enable the microscale abrasive grains to obtain a good graphitized removal efficiency and prevent a large number of melts from adhering to a surface of a binding agent of the grinding wheel during discharge.

Factors such as a mesh number of the grinding wheel, the pulse discharge parameters and the movement parameters of the machine tool directly affect the graphitized removal efficiency of the cutting edge of the abrasive grains. During in-position truncating, since the pulse discharge parameters and the movement parameters of the machine tool are usually controlled in specific ranges, the maximum truncating area of the cutting edge and the maximum effective number of rotations of the grinding wheel mainly depend on the mesh number of the grinding wheel. Different mesh numbers of the grinding wheel further correspond to different control ranges of the pulse discharge parameters and the movement parameters of the machine tool. Therefore, a large amount of experimental data need to be obtained in an early stage and the expert database is established by a neural network, deep learning and other manners, so as to precisely control the truncating parameters of the microscale abrasive grains of different mesh numbers online.

As a preferred solution, in step \textcircled{2}, a method to feedback control the movement parameters of the machine tool and the parameters of the power supply is as follows: adjusting a rotation speed of the grinding wheel or/and a feeding speed of the workstation first, then adjusting a current limiting value, and adjusting the open circuit voltage again; if control requirements are still unable to be met, adjusting a cutting depth and re-planning the grinding wheel path finally.

Further, in a stage of adjusting the movement parameters of the machine tool or/and the parameters of the power supply: when the discharge current is less than 3 A or/and the discharge voltage is 5 V lower than the open circuit voltage of the power supply, the rotation speed of the grinding wheel or/and the current limiting value are increased, and the feeding speed of the workstation or/and the open circuit voltage or/and the cutting depth are decreased. When the discharge current is greater than 6 A or/and the discharge voltage is 2 V greater than the open circuit voltage of the power supply, the rotation speed of the grinding wheel or/and the current limiting value are decreased, and the feeding speed of the workstation or/and the open circuit voltage or/and the cutting depth are increased. The rotation speed of the grinding wheel ranges from 1500 rpm to 3000 rpm, the feeding speed of the workstation ranges from 20 mm/min to 200 mm/min, the cutting depth ranges from 1 μm to 3 μm, the open circuit voltage ranges from 15 V to 30 V, and the current limiting value ranges from 0.1 A to 2 A.

The reason why the preferred solution is used for adjustment is that: the pulse discharge parameters are increased with increase of a discharge gap (a load resistance) during in-position truncating, and the discharge gap is related to the movement parameters of the machine tool and the protrusion height of the abrasive grains. According to a working principle of constant-voltage and constant-current conversion of the power supply, the discharge gap is controlled by adjusting the movement parameters of the machine tool, especially the rotation speed of the grinding wheel and the feeding speed of the workstation, to generate good electric spark discharge, and then graphitized removal is performed on the cutting edge thereof on a premise that the microscale abrasive grains do not fall off. Moreover, discharge energy can be increased/decreased by adjusting the parameters of the power supply, but formation of the discharge gap is not affected. In addition, since the cutting depth can only be determined by an imported movement program of the machine tool, the grinding wheel path needs to be re-planned after adjusting the cutting depth.

Further, in step \textcircled{3}, the target value is determined by machining quality grades in the expert database according to actual use requirements of a workpiece.

Further, the machine tool-PC online monitoring software and the power supply-PC online monitoring software include manual control and remote control functions, wherein a manner to read and transmit data of the remote control function is to read and transmit data in real time or in every 1 minute to 5 minutes.

Further, the machine tool-PC online monitoring software includes functions of adjusting a spindle rate and a feeding rate, separating the grinding wheel and the electrode and respectively decelerating the same to zero when reading the stop command; and the power supply-PC online monitoring software includes functions of adjusting the open circuit voltage, the current limiting value, a duty ratio and a frequency.

Further, the power supply is a direct current power supply, the electrode is an iron-based electrode, the voltage sensor and the current sensor are a high-frequency response voltage sensor and a high-frequency response current sensor respectively; and a grain size of the diamond grinding wheel ranges from #24 to #240.

Further, in step \textcircled{4}, the calculating the truncating area of the cutting edge and the protrusion height of the truncating microscale abrasive grains by the number of rotations of the grinding wheel, the pulse discharge parameters and the movement parameters of the machine tool includes the steps:

calculating the protrusion height He of the truncating microscale abrasive grains;

$${H}_{c} = a {U}_{c}^{b} {I}_{c}^{c} + d ( 1 + \frac{{v}_{f}}{π D N} ) {( {D}^{3} {a}_{p} )}^{3 / 10} \qquad ( 1 )$$

wherein a, b and c are coefficients related to the parameters of the power supply and electrode materials, and U_{c} is the discharge voltage; I_{c} is the discharge current, d is a coefficient related to a cutting chip length, D is a diameter of the grinding wheel, N is the rotation speed of the grinding wheel, v_{f} is a feeding speed of the workstation, and aₚ is the cutting depth; and

calculating the truncating area s_{c}^{(k)} of the cutting edge of the truncating microscale abrasive grains:

$${s}_{c}^{( k )} = ( \sqrt{{s}_{c max}} - \sqrt{{s}_{c t}} ) \sqrt[3]{\frac{{n}_{max} \sqrt{{s}_{c t}} + k ( \sqrt{{s}_{c max}} - \sqrt{{s}_{c t}} ) ( {s}_{c t} + {s}_{c max} + \sqrt{{s}_{c {max}^{{S}_{c t}}}} )}{{n}_{max} [ \sqrt{{s}_{c t}} + ( \sqrt{{s}_{c max}} - \sqrt{{s}_{c t}} ) ( {s}_{c t} + {s}_{c max} + \sqrt{{s}_{c {max}^{{S}_{c t}}}} ) ]}} \qquad ( 2 )$$

wherein s_{cmax} is the maximum truncating area of the cutting edge, nₘₐₓ is the maximum effective number of rotations of the grinding wheel, k is the calculated number of rotations of the grinding wheel during in-position truncating, s_{ct} is the area of the cutting edge of the microscale abrasive grains before truncating; and in an initial state, s_{ct}≤1000 μm².

Beneficial Effects of the Invention

Beneficial Effects

Compared with the prior art, the present invention has the following beneficial effects.

1. The truncating area and the protrusion height of the truncating microscale abrasive grains may be evaluated online by the number of rotations of the grinding wheel, the pulse discharge parameters and the movement parameters of the machine tool fed back by the in-position truncating system without using the robot vision technology, thus avoiding complicated detection and data processing, and providing theoretical and technical supports for intelligent control of truncating of the microscale abrasive grains.

2. Since the number of rotations of the grinding wheel may be adjusted flexibly during the truncating, the truncating areas of the cutting edges of different sizes may be obtained only by controlling the number of rotations of the grinding wheel, and this adjustment manner is flexible and convenient, and may realize real-time adjustment to meet machining quality requirements of different parts.

3. A stability of the system is not affected by external factors such as electric spark discharge and molten cutting chips splashing, the system is low in development cost and simple in operation, and the system can also be applied to online control of process parameters of precision grinding/discharge grinding.

### BRIEF DESCRIPTION OF THE DRAWINGS

### Description of the Drawings

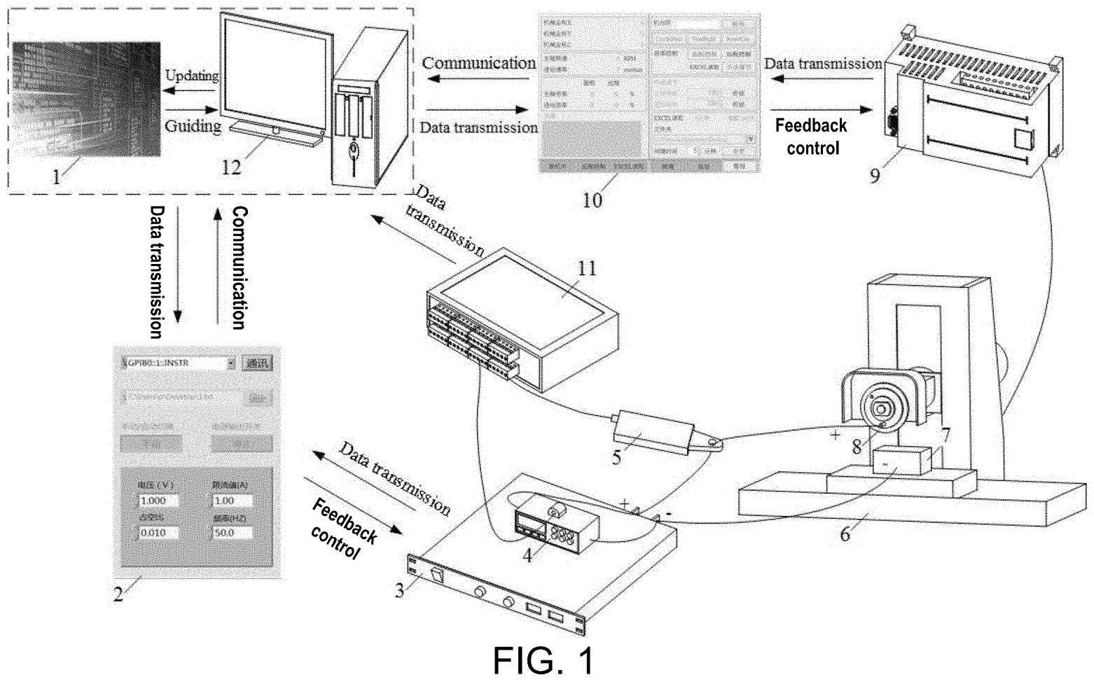

FIG. 1 is a diagram illustrating an in-position truncating system of microscale abrasive grains.

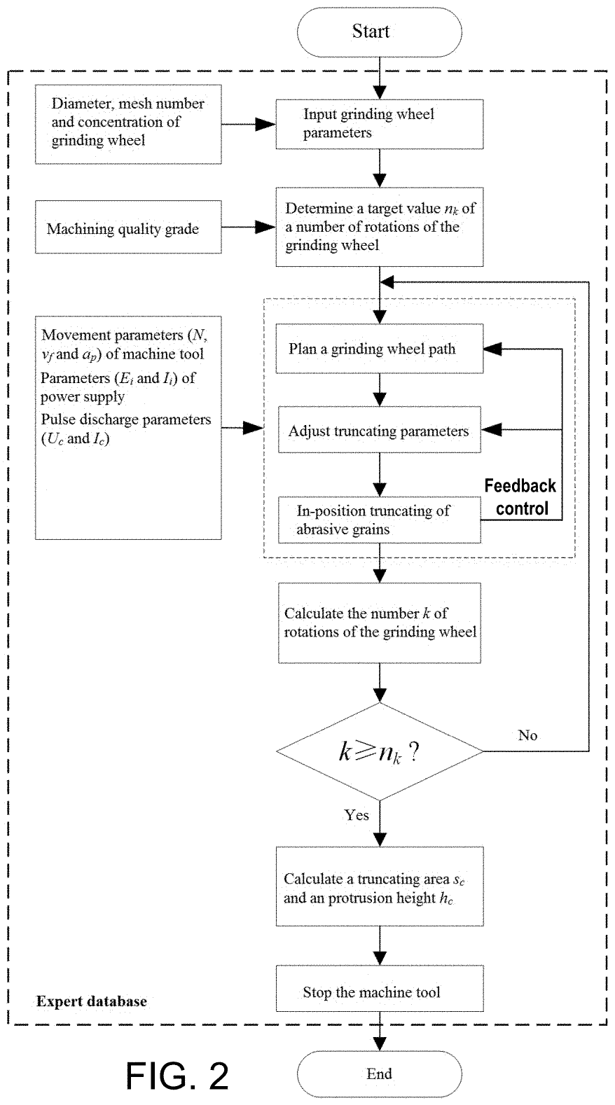

FIG. 2 is a flow chart illustrating online precise control of truncating parameters of the microscale abrasive grains.

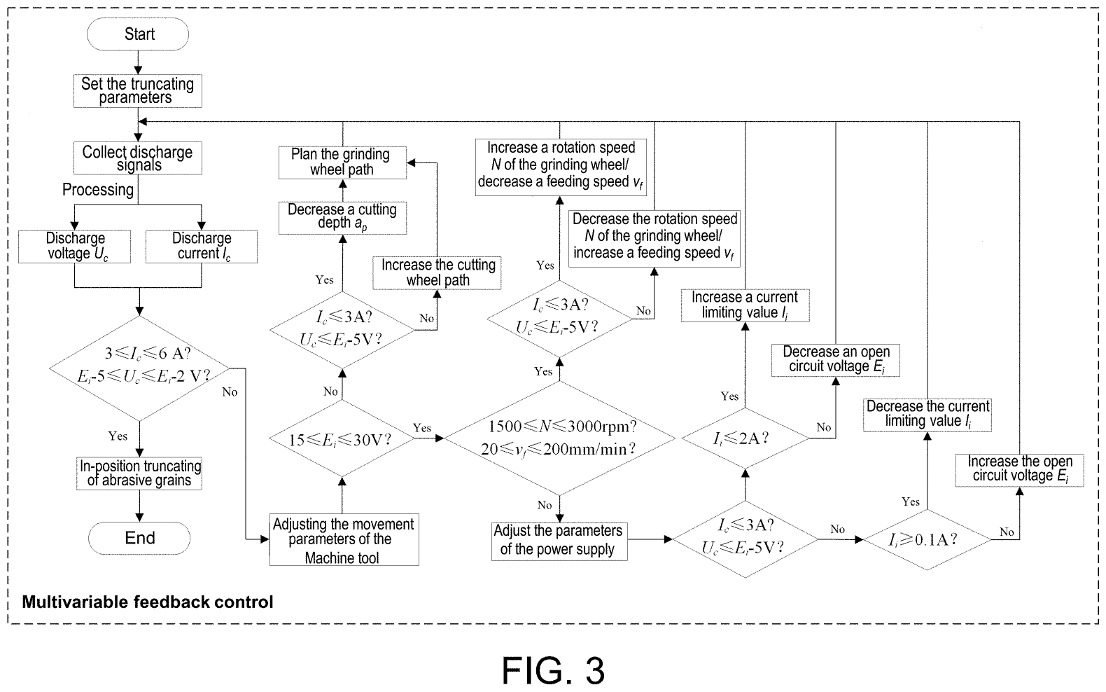

FIG. 3 is a flow chart illustrating multivariable feedback control on in-position truncating of the microscale abrasive grains.

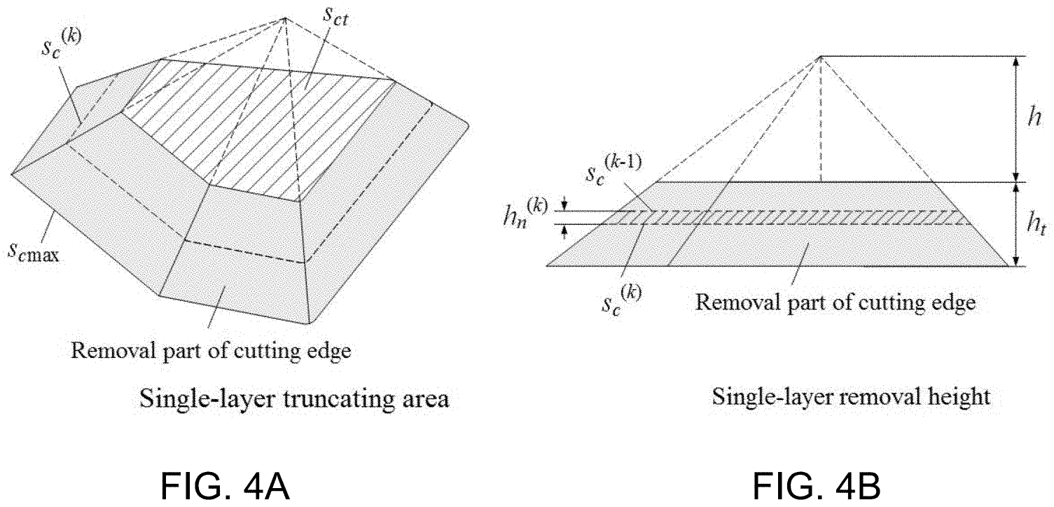

FIG. 4(a) is a diagram illustrating a calculation model of a single-layer truncating area of a cutting edge.

FIG. 4(b) is a diagram illustrating a calculation model of a single-layer removal height of the cutting edge.

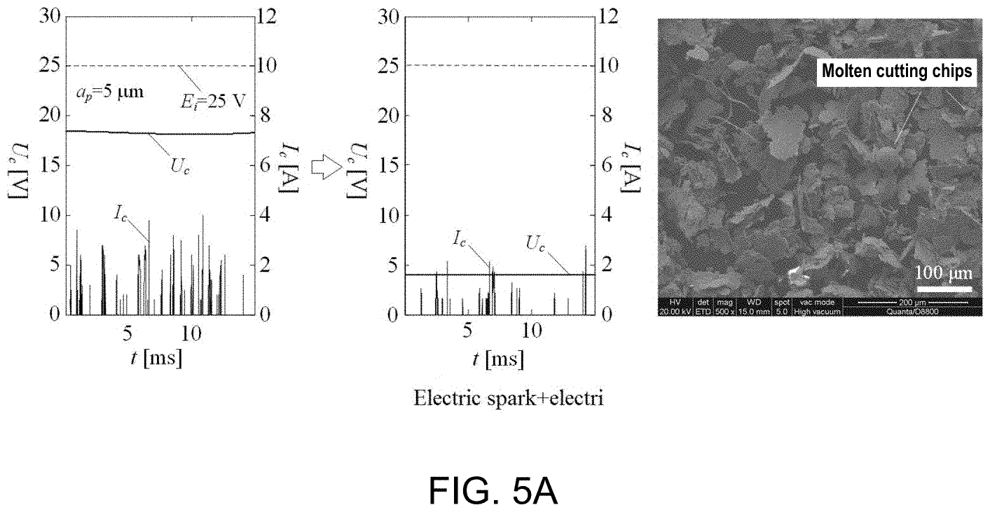

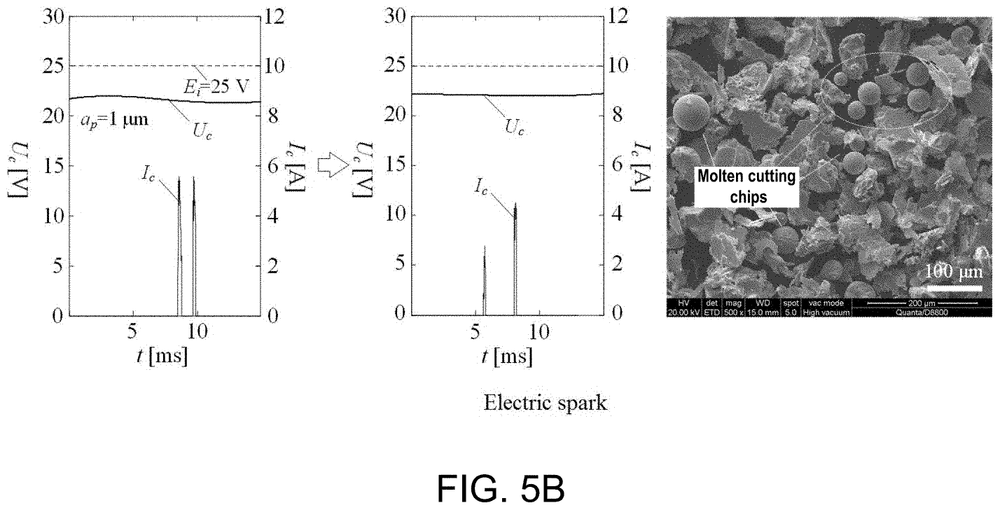

FIG. 5(a) shows pulse discharge waveform tracing when the microscale abrasive grains are truncated by electric spark and electric arc discharge during truncating and a corresponding cutting chips electron micrograph.

FIG. 5(b) shows pulse discharge waveform tracing when the microscale abrasive grains are truncated by electric spark discharge during truncating and a corresponding cutting chips electron micrograph.

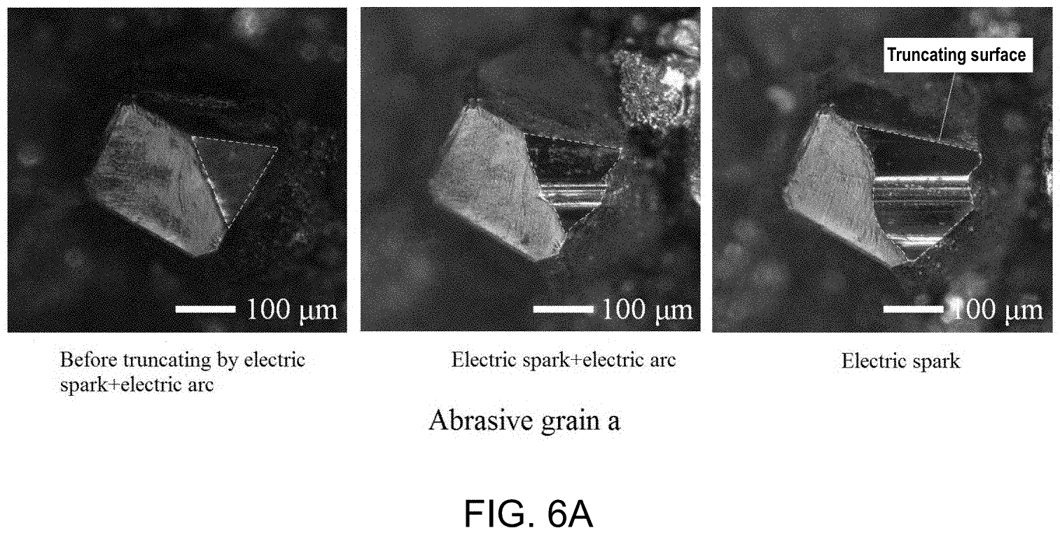

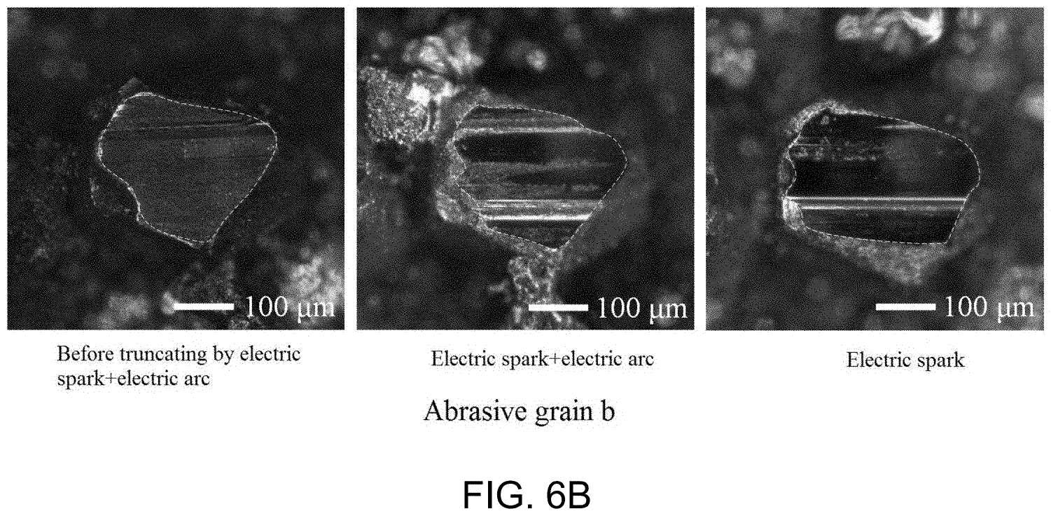

FIG. 6(a) is an electron micrograph illustrating a microscale abrasive grain topography of an abrasive grain a under different truncating parameters.

FIG. 6(b) is an electron micrograph illustrating a microscale abrasive grain topography of an abrasive grain b under different truncating parameters.

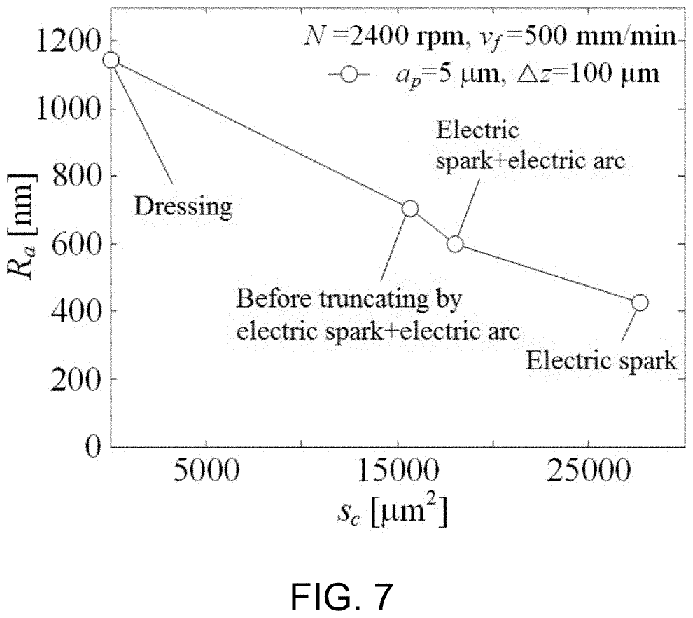

FIG. 7 is a graph illustrating a relationship between a truncating area of the cutting edge and a surface roughness of a workpiece.

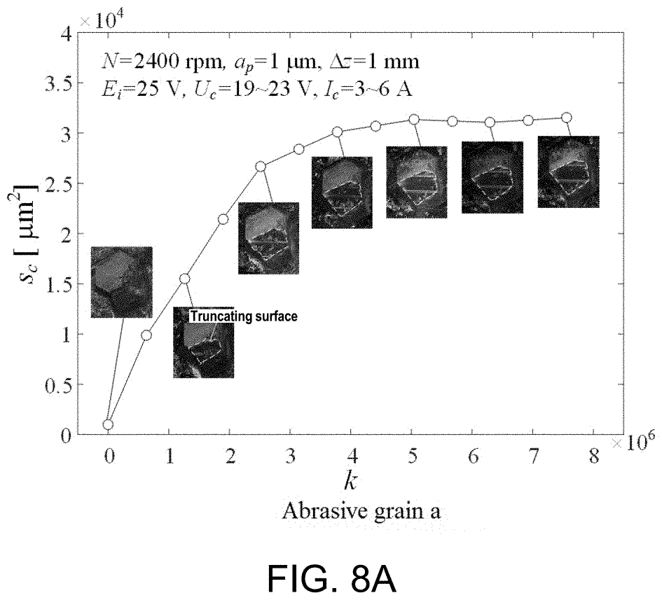

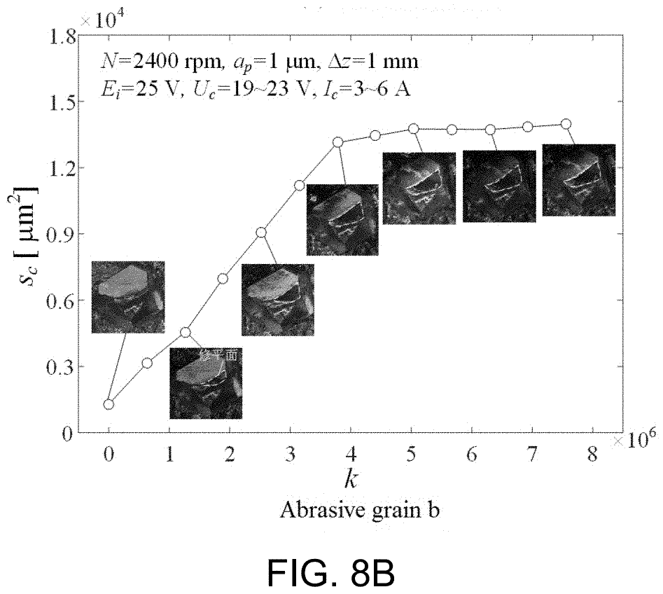

FIG. 8(a) is a graph illustrating a change of the truncating area of the cutting edge of the abrasive grain a with a number of rotations of a grinding wheel.

FIG. 8(b) is a graph illustrating a change of the truncating area of the cutting edge of the abrasive grain b with the number of rotations of the grinding wheel.

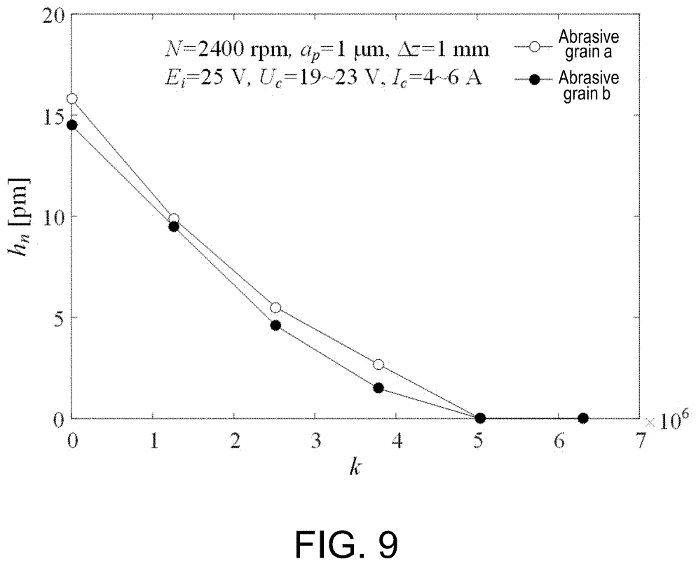

FIG. 9 is a graph illustrating changes of single-layer removal heights of the cutting edges of the abrasive grain a and the abrasive grain b with the number of rotations of the grinding wheel.

In the drawings: 1 refers to expert database; 2 refers to power supply-PC online monitoring software; 3 refers to power supply; 4 refers to voltage sensor; 5 refers to current sensor; 6 refers to numerical control machine tool; 7 refers to electrode; 8 refers to diamond grinding wheel; 9 refers to controller of numerical control machine tool; 10 refers to machine tool-PC online monitoring software; 11 refers to data collection card; and 12 refers to workstation.

### DETAILED DESCRIPTION OF THE EMBODIMENTS

### Embodiments of the Invention

The present invention is further described in detail hereinafter with reference to the embodiments and the accompanying drawings, but the embodiments of the present invention are not limited thereto.

Referring to FIG. 1 to FIG. 9, truncating of a #46 diamond grinding wheel is taken as an example. A working principle of an online precise control method for truncating parameters of microscale abrasive grains of the present invention is described in detail, and then the technical effect of the present invention is verified.

An in-position truncating system of the microscale abrasive grains is as shown in FIG. 1, an electrode 7 and a diamond grinding wheel 8 to be truncated are clamped on a numerical control machine tool 6. The diamond grinding wheel 8 (+), the electrode 7 (−), a power supply 3, a voltage sensor 4, a current sensor 5 and a data collection card 11 are connected in a positive electrode manner to form a discharge circuit. An expert database 1 is installed on a workstation 12, and the workstation 12 is communicated with the power supply 3 and a controller 9 of the numerical control machine tool by power supply-PC online monitoring software 2 and machine tool-PC online monitoring software 10.

The power supply-PC online monitoring software 2 and the machine tool-PC online monitoring software 10 may read a data file generated by the workstation 12 under a specified path in real time or in every 1 minute to 5 minutes and transmit the same to the power supply 3 and the controller 9 of the numerical control machine tool respectively, thus adjusting an open circuit voltage, a current limiting value, a duty ratio and a frequency of the power supply, as well as a spindle rate (a rotation speed of a grinding wheel) and a feeding rate (a feeding speed of the workstation) of the machine tool. The data collection card 11 may collect pulse discharge signals sent by the voltage sensor 4 and the current sensor 5 online and transmit data to the workstation 12. In addition, empirical data such as pulse discharge parameters, a maximum truncating area of a cutting edge and a maximum effective number of rotations of the grinding wheel corresponding to different grinding wheel parameters in the expert database 1 may be used for precisely controlling the truncating parameters of the microscale abrasive grains online. These data are obtained by a preliminary experiment first, and then trained by a neural network and deep learning after accumulating enough experimental data, so as to meet online precise control requirements of different truncating parameters of the microscale abrasive grains.

FIG. 2 is a flow chart of online precise control of the truncating parameters of the microscale abrasive grains. Specific steps are described as follows.

\textcircled{1} Before truncating of the microscale abrasive grains, the grinding wheel parameters such as a diameter, a mesh number and a concentration of the grinding wheel are inputted to the workstation 12, machining quality grades are set according to machining requirements of actual parts to determine a target value nₖ of the number of rotations of the grinding wheel through the expert database 1. Moreover, the parameters (an open circuit voltage Eᵢ and a current limiting value Iᵢ) of the power supply, and the movement parameters (the rotation speed N of the grinding wheel, the feeding speed v_{f} of the workstation and the cutting depth aₚ) of the machine tool are preliminarily set according to the corresponding empirical data in the expert database 1, and the grinding wheel path is planned.

\textcircled{2} The in-position truncating of the microscale abrasive grains is performed, according to collected pulse discharge parameters (a discharge voltage U_{c} and a discharge current I_{c}), the movement parameters of the machine tool and the parameters of the power supply are feedback controlled by the machine tool-PC online monitoring software 10 and the power supply-PC online monitoring software 2 respectively, and the discharge current and the discharge voltage are controlled in a range of 3 A to 6 A and in a range that is 2 V to 5 V lower than an open circuit voltage of the power supply respectively, so as to obtain a good graphitized removal efficiency of the cutting edge of the microscale abrasive grains.

\textcircled{3} During in-position truncating, in order to precisely control the truncating parameters of the microscale abrasive grains online, a maximum truncating area s_{cmax} of the cutting edge and a maximum effective number nₘₐₓ of rotations of the grinding wheel under the corresponding grinding wheel parameters, the corresponding pulse discharge parameters and the corresponding movement parameters of the machine tool are selected from the expert database 1, and the number k of rotations of the grinding wheel is calculated in real time, which is compared with the determined target value nₖ.

\textcircled{4} When the calculated number k of rotations of the grinding wheel is greater than the target value nₖ, the truncating area and the protrusion height of the truncating microscale abrasive grains are calculated according to a single-layer truncating area model of the cutting edge and an protrusion height model of the abrasive grains established by using the number k of rotations of the grinding wheel, the pulse discharge parameters (U_{c} and I_{c}) and the movement parameters (N, v_{f} and aₚ) of the machine tool. Moreover, the workstation 12 sends a stop command to the machine tool-PC online monitoring software 10, and when the controller 9 of the numerical control machine tool reads the stop command, the diamond grinding wheel 8 and the electrode 7 are separated and respectively decelerated to zero.

FIG. 3 shows a feedback control flow of the in-position truncating of the microscale abrasive grains. Specific steps are described as follows.

\textcircled{1} During the in-position truncating of the microscale abrasive grains, the data collection card 11 intermittently collects the pulse discharge signals sent by the voltage sensor 4 and the current sensor 5, and after the workstation 12 obtains the discharge voltage U_{c} and the discharge current I_{c} through data processing, whether the discharge voltage U_{c} and the discharge current I_{c} are in the range of 3 A to 6 A and in the range that is 2 V to 5 V lower than the open circuit voltage of the power supply respectively is judged. If the discharge voltage U_{c} and the discharge current I_{c} are in the range of 3 A to 6 A and in the range that is 2 V to 5 V lower than the open circuit voltage of the power supply respectively, the in-position truncating is continued, otherwise, the pulse discharge parameters are feedback controlled.

\textcircled{2} In a feedback control stage, priority is given to adjustment of the rotation speed N of the grinding wheel or/and the feeding speed v_{f} of the workstation in the movement parameters of the machine tool, then to adjustment of the current limiting value Iᵢ, then to adjustment of the open circuit voltage Eᵢ, and finally to adjustment of the cutting depth aₚ if control requirements are still unable to be met. Step size setting of parameter adjustment includes the rotation speed N of the grinding wheel of 100 rpm/once to 200 rpm/once, the feeding speed v_{f} of the workstation of 100 mm/min/once to 200 mm/min/once, the cutting depth aₚ of 1 μm/once, the current limiting value Iᵢ of 0.1 A/once to 0.2 A/once, and the open circuit voltage Eᵢ of 2 V/once to 5 V/once.

\textcircled{3} When the open circuit voltage is 15≤E₁≤30 V, whether the rotation speed N of the grinding wheel and the feeding speed v_{f} of the workstation are in the range of 1500 rpm≤N≤3000 rpm and in the range of 20 mm/min≤v_{f}≤200 mm/min is judged. If the rotation speed N of the grinding wheel and the feeding speed v_{f} of the workstation are in the range of 1500 rpm≤N≤3000 rpm and in the range of 20 mm/min≤v_{f}≤200 mm/min, the movement parameters (N and v_{f}) of the machine tool are adjusted, otherwise, the parameters (Eᵢ and Ii) of the power supply are adjusted.

\textcircled{4} In a stage of adjusting the movement parameters (N and v_{f}) of the machine tool, whether the discharge current and the discharge voltage are I_{c}≤3 A and Uc≤Eᵢ−5 V is judged, if the discharge current and the discharge voltage are I_{c}≤3 A and Uc≤Eᵢ−5 V, the rotation speed N of the grinding wheel is increased or/and the feeding speed v_{f} of the workstation is decreased, otherwise, the rotation speed N of the grinding wheel is decreased or/and the feeding speed v_{f} of the workstation is increased

\textcircled{5} In a stage of adjusting the parameters (Eᵢ and Iᵢ) of the power supply, when I_{c}≤3 A and U_{c}≤Eᵢ−5 V, whether the current limiting value is Iᵢ≤2 A is judged, if the current limiting value is Iᵢ≤2 A, the current limiting value Iᵢ is increased, otherwise, the open circuit voltage Eᵢ is decreased. When I_{c}≥6 A and U_{c}≥Eᵢ−2 V, whether the current limiting value is Iᵢ≥0.1 A is judged, if the current limiting value is Iᵢ≥0.1 A, the current limiting value Iᵢ is decreased, otherwise, the open circuit voltage Eᵢ is increased.

\textcircled{6} After the movement parameters (N and v_{f}) of the machine tool and the parameters (Eᵢ and Ii) of the power supply are adjusted, if the control requirements are still unable to be met, the cutting depth aₚ is considered to be adjusted finally, which means that, when the open circuit voltage is Eᵢ≤15 V or Eᵢ≥30 V, whether the discharge current and the discharge voltage are I_{c}≤3 A and U_{c}≤Eᵢ−5 V is judged, if the discharge current and the discharge voltage are I_{c}≤3 A and U_{c}≤Eᵢ−5 V, the cutting depth aₚ is decreased, otherwise, the cutting depth aₚ is increased. In addition, when the cutting depth is adjusted, the grinding wheel path under a single cutting depth needs to be completed before re-planning the path.

Experimental results show that the discharge gap between raised cutting chips and a binding agent of the grinding wheel can be decreased by decreasing the rotation speed of the grinding wheel or increasing the feeding speed of the workstation and the cutting depth during truncating of the microscale abrasive grains of the grinding wheel, and an influence of the cutting depth is far greater than those of the rotation speed of the grinding wheel and the feeding speed of the workstation. A pulse discharge voltage can be decreased by 1 V to 1.5 V for every increase of the cutting depth by 1 μm, and the cutting chips are easy to accumulate in the discharge gap to generate pulse arc discharge. According to a principle of constant-voltage and constant-current conversion of the power supply, discharge energy may be changed by adjusting the current limiting value Iᵢ and the open circuit voltage Eᵢ, which will directly affect a removal efficiency of the binding agent of the grinding wheel. Moreover, the current limiting value Ii is used as a critical value of the constant-voltage and constant-current conversion, which directly affects an energy utilization rate of the power supply. Therefore, the above solution is used for adjustment.

Whether a truncating effect of the microscale abrasive grains may be precisely controlled online by the number of rotations of the grinding wheel, the pulse discharge parameters and the movement parameters of the machine tool fed back by the system during the in-position truncating may be verified theoretically.

The diamond grinding wheel 8 grinds the electrode 7 during the in-position truncating, so that the discharge gap is formed between the raised cutting chips and the surface of the binding agent of the grinding wheel, and pulse electric spark discharge is generated under the open circuit voltage Eᵢ outputted by the power supply 3. Moreover, the protrusion height of the abrasive grains is approximately a sum of the discharge gap and a cutting chips raising height. The discharge gap is related to the pulse discharge parameters (U_{c} and I_{c}), and the cutting chips raising height is proportional to a cutting length, and is affected by the movement parameters (the rotation speed N of the grinding wheel, the feeding speed v_{f} of the workstation and the cutting depth ap) of the machine tool. Therefore, the protrusion height H_{c} of the abrasive grains is:

$${H}_{c} = a {U}_{c}^{b} {I}_{c}^{c} + d ( 1 + \frac{{v}_{f}}{π D N} ) {( {D}^{3} {a}_{p} )}^{3 / 10} \qquad ( 1 )$$

wherein a, b and c are coefficients related to the parameters of the power supply and electrode materials, d is a coefficient related to the cutting chip length, and D is a diameter of the grinding wheel.

Calculation models of the single-layer removal height and the truncating area of the cutting edge are as shown in FIG. 4(a) and FIG. 4 (b). Outlines of the cutting edge of the microscale abrasive grains before and after truncating are similar during the in-position truncating. Assuming that a single-layer removal volume of the cutting edge of the microscale abrasive grains in a certain period of time is a fixed value, the fixed value is related to factors such as the mesh number of the grinding wheel and the pulse discharge parameters. Therefore, the single-layer removal height hₙ^{(k)} and the truncating area s_{c}^{(k)} of the cutting edge are respectively:

$$\begin{matrix}{h}_{n}^{( k )} = \frac{{h}_{t} \sqrt{{s}_{c max}}}{\sqrt{{s}_{c max}} - \sqrt{{s}_{c t}}} \sqrt[3]{\frac{{n}_{max} \sqrt{{s}_{c t}} + k ( \sqrt{{s}_{c max}} - \sqrt{{s}_{c t}} ) ( {s}_{c t} + {s}_{c max} + \sqrt{{s}_{c max} {s}_{c t}} )}{{n}_{max} [ \sqrt{{s}_{c t}} + ( \sqrt{{s}_{c max}} - \sqrt{{s}_{c t}} ) ( {s}_{c t} + {s}_{c max} + \sqrt{{s}_{c max} {s}_{c t}} ) ]}} - \frac{{h}_{t} \sqrt{{s}_{c t}}}{\sqrt{{s}_{c max}} - \sqrt{{s}_{c t}}} & ( 2 ) \\ {s}_{c}^{( k )} = ( \sqrt{{s}_{c max}} - \sqrt{{s}_{c t}} ) \sqrt[3]{\frac{{n}_{max} \sqrt{{s}_{c t}} + k ( \sqrt{{s}_{c max}} - \sqrt{{s}_{c t}} ) ( {s}_{c t} + {s}_{c max} + \sqrt{{s}_{c {max}^{{S}_{c t}}}} )}{{n}_{max} [ \sqrt{{s}_{c t}} + ( \sqrt{{s}_{c max}} - \sqrt{{s}_{c t}} ) ( {s}_{c t} + {s}_{c max} + \sqrt{{s}_{c {max}^{{S}_{c t}}}} ) ]}} & ( 3 )\end{matrix}$$

wherein hₜ is a total removal height of the abrasive grains, s_{ct} is an area of the cutting edge of the microscale abrasive grains before truncating, and in an initial state, s_{ct}≤1000 μm².

To sum up, if the maximum truncating area s_{cmax} of the cutting edge and the maximum effective number nₘₐₓ of rotations of the grinding wheel rotation under the corresponding grinding wheel parameters, the pulse discharge parameters and the movement parameters of the machine tool are known, the truncating area and the protrusion height of the microscale abrasive grains may be calculated according to the formulas (1) and (3) by calculating the number k of rotations of the grinding wheel during truncating. In addition, influences of the grinding wheel path and the movement parameters of the machine tool need to be considered when calculating the number k of rotations of the grinding wheel.

It should be emphasized that detection of the microscale abrasive grains and extraction of topographical feature parameters thereof usually depend on precise detection instruments such as white light interference and super depth of field, which means that it is also difficult to monitor truncating of the microscale abrasive grains by a robot vision system online. Moreover, the technology described in the present invention is not simple superposition of the prior arts either, and an essential difference thereof lies in the online precise control of the truncating parameters of the microscale abrasive grains by the number of rotations of the grinding wheel, the pulse discharge parameters and the movement parameters of the machine tool, which is not the basic common sense in the art. Moreover, due to different evaluation manners of the truncating parameters of the microscale abrasive grains and theoretical bases thereof, even if those skilled in the art combine the basic common sense in the art with limited experiments, the expert database related to the technology described in the present invention cannot be established.

A necessity of feedback control of the pulse discharge parameters and the movement parameters of the machine tool in the present invention and an acquisition method of parameters such as machining quality grades, the maximum truncating area s_{cmax} of the cutting edge, and the maximum effective number nₘₐₓ of rotations of the grinding wheel in the expert database are described by the embodiments below.

### Embodiment 1

In a truncating experiment of microscale abrasive grains, a #46 diamond grinding wheel (a diameter D=150 mm and a bronze binding agent) and an iron electrode (45 steel) are fixed on a numerical control machine tool (SMART 818), and are connected with a graphite brush, an oscilloscope (DS1102E), a direct current power supply (DCS80), a voltage sensor and a current sensor (RP1000D and RP1001C) in a positive electrode manner to form a discharge circuit. In order to generate different electric spark discharges, the experiment is performed with an open circuit voltage of Eᵢ=25 V, a current limiting value of Iᵢ=0.1 A, a rotation speed of a grinding wheel of N=2400 rpm, a feeding speed of a workstation of v_{f}=80 mm/min, axial feeding of Δz=1 mm, and a cutting depth of aₚ=1 μm and 5 μm, and a truncating time of each group is 20 hours.

Pulse discharge waveform tracing and cutting during truncating of the microscale abrasive grains are as shown in FIG. 5(a) and FIG. 5(b). According to a principle of constant-voltage and constant-current conversion of a power supply, electric spark discharge may be gradually converted to electric spark and electric arc discharge with increase of the cutting depth aₚ during the truncating. An amplitude of a discharge voltage U_{c} of the electric spark and electric arc discharge is less than 18 V and unstable, and is easy to be lowered to be less than 4 V, while a frequency of the discharge current I_{c} is greater than 400 Hz, but the amplitude is less than 3 A. Amplitudes of a discharge voltage U_{c} and a discharge current I_{c} of the electric spark discharge are always greater than 20 V and 3 A, while a frequency of a discharge current I is less than 100 Hz. In addition, compared with the electric spark and electric arc discharge, cutting chips generated by truncating by the electric spark discharge are doped with a large number of spherical melts.

Topographies of the microscale abrasive grains under different truncating parameters are as shown in FIG. 6(a) and FIG. 6(b). Under the electric spark and electric arc discharge, a truncating surface of the microscale abrasive grains does not change obviously, a single-layer removal height thereof is about 3.2 pm/r, and a truncating efficiency is 3390 μm³/min. Under the electric spark discharge, the microscale abrasive grains on the grinding wheel are quickly truncated at an efficiency of 5520 μm³/min, and the single-layer removal height thereof may reach 4.1 pm/r. Therefore, truncating areas of abrasive grains a and b under the electric spark discharge are increased by 118% and 34% compared with those under the electric spark and electric arc discharge, so that alignment σ of the abrasive grains is improved by 26%.

FIG. 5 and FIG. 6 show that heat released by the electric spark and electric arc discharge is far less than that of the electric spark discharge, and a necessary condition for obtaining a good graphitized removal efficiency of the cutting edge of the microscale abrasive grains is that the cutting edge absorbs enough heat. Therefore, it is necessary to feedback control the pulse discharge parameters and the movement parameters of the machine tool during in-position truncating, so as to generate stable electric spark discharge, which means that a discharge current and a discharge voltage are controlled in a range of 3 A to 6 A and in a range that is 2 V to 5 V lower than an open circuit voltage of the power supply respectively.

In addition, according to the above experimental data, four coefficients a, b, c and d in the formula (1) may be determined, so that a specific formula for calculating the protrusion height of the abrasive grains is as follows:

$${h}_{c} = 0.00346 {U}_{c}^{3.203 \; 9} {I}_{c}^{- 0.2355} + 0.00115 ( 1 + \frac{{v}_{f}}{π D N} ) {( {D}^{3} {a}_{p} )}^{3 / 10} \qquad ( 4 )$$

It should be noted that, when a power supply model, an electrode, a binding agent of the grinding wheel and other conditions are changed, a coefficient in an protrusion height model of the abrasive grains may also be changed, but a structural form is not changed, which means that the formula (4) is only used as an example in the present invention.

A relationship between a truncating area of the cutting edge and a surface roughness of a workpiece is as shown in FIG. 7. Taking grinding of D-star die steel as an example, the surface roughness Ra of the workpiece is decreased with increase of the truncating area sc. Compared with sharpening, the truncating area of the truncated cutting edge may reach 27690 μm², thus increasing the surface roughness of the workpiece by 63%, indicating that the truncated microscale abrasive grains may be used for precision machining of materials difficult to be cut due to a large stiffness coefficient, a smooth and flat truncating surface, high protrusion and good alignment. Therefore, machining quality grades of the die steel may be further divided through the relationship between the truncating area and the surface roughness, and corresponding truncating areas under different machining quality grades are determined. For example, a machining quality grade 3 (rough machining)−s_{c}=0, which is namely the sharpening; a machining quality grade 2 (semi-finishing)-s_{c}=12000 μm²; and a machining quality grade 1 (finish machining)−s_{c}=20000 μm².

Acquisition methods of the maximum truncating area s_{cmax} of the cutting edge and the maximum effective number nₘₐₓ of rotations of the grinding wheel in the expert database of the present invention are described by another embodiment below.

### Embodiment 2

Similarly, a #46 diamond grinding wheel (a diameter D=150 mm and a bronze binding agent) and an iron electrode (45 steel) are fixed on a numerical control machine tool (SMART 818), and are connected with a graphite brush, an oscilloscope (DS1102E), a direct current power supply (DCS80), a voltage sensor and a current sensor (RP1000D and RP1001C) in a positive electrode manner to form a discharge circuit. An experiment is performed with an open circuit voltage of E=25 V, a rotation speed of a grinding wheel N=2400 rpm, a cutting depth of aₚ=1 μm (electric spark discharge), and axial feeding of Δz=1 mm. In order to control a discharge current and a discharge voltage in a range of 3 A to 6 A and in a range of 19 V to 23 V respectively, a feeding speed v_{f} (initial value v_{f}=80 mm/min) of a workstation or a current limiting value (initial value Ii=0.1 A) is adjusted during in-position truncating, and a topography of microscale abrasive grains on a grinding wheel block is detected every 1.26×10⁶ times of rotation.

As shown in FIG. 8(a) and FIG. 8(b), a truncating area s_{c} of the cutting edge is gradually increased with increase of a number k of rotations of the grinding wheel, but when k>5.04×10⁶ truncating areas of cutting edges of an abrasive grain a and an abrasive grain b are respectively stabilized at 31000 μm² and 13700 μm². In addition, according to a formula (2), a single-layer removal height hₙ of the microscale abrasive grains in each truncating stage may be calculated, and a change rule thereof is as shown in FIG. 9: the single-layer removal heights hₙ (weighted averages) of the abrasive grain a and the abrasive grain b are decreased from 15.8 pm/r and 14.5 pm/r to 2.7 pm/r and 1.5 pm/r respectively with increase of the number of rotations of the grinding wheel, and finally approach to 0, indicating that a graphitized removal efficiency is further decreased due to increase of a stiffness coefficient thereof and drastic decrease of surface temperature rise of the cutting edge during gradual truncating of the microscale abrasive grains.

According to analysis in FIG. 8 and FIG. 9, when the number k of rotations of the grinding wheel is greater than 5.04×10⁶, the truncating area of the cutting edge is no longer changed. However, an average single-layer removal height is only 2.1 pm/r under 3.78×10⁶<k<5.04×10⁶, which is inconsistent with actual production requirements in terms of an efficiency and a cost. Therefore, a maximum truncating area s_{cmax} of the cutting edge and a maximum effective number nₘₐₓ of rotations of the grinding wheel of a #46 diamond grinding wheel under pulse discharge parameters of I_{c}=3 A to 6 A and U_{c}=19 V to 23 V are determined to be s_{cmax}=21600 μm² and nₘₐₓ=3.78×10⁶ respectively. After determining the maximum truncating area s_{cmax} of the cutting edge and the maximum effective number nₘₐₓ of rotations of the grinding wheel, a target value nₖ of the number of rotations of the grinding wheel corresponding to different machining grades (the truncating area s_{c} of the cutting edge) may be further obtained by a formula (3). Moreover, according to the above Embodiments 1 and 2, initial movement parameters of a machine tool and initial parameters of a power supply set during in-position truncating by #46 microscale abrasive grains are respectively determined to be: N=2400 rpm, v_{f}=80 mm/min. aₚ=1 Eᵢ=25 V and Iᵢ=0.1 A, as well as Δz=1 mm in a grinding wheel path.

To sum up, truncating parameters of the microscale abrasive grains are precisely controlled online by the above method, which can not only simplify extraction and analysis of the truncating parameters of the microscale abrasive grains, but also obtain different truncating areas of the cutting edge by flexibly adjusting the number of rotations of the grinding wheel, thus meet machining quality requirements of different parts.

The above is the preferred embodiments of the present invention, but the embodiments of the present invention are not limited by the above contents. Any other changes, modifications, substitutions, combinations, and simplifications made without departing from the spirit and principle of the present invention shall be equivalent substitute manners, and shall be included in the scope of protection of the present invention.

The present invention discloses the online precise control method for truncating parameters of microscale abrasive grains, which includes the steps of: \textcircled{1} clamping the electrode and the diamond grinding wheel to form the discharge circuit, and communicating the workstation with the power supply and the controller of the numerical control machine tool; \textcircled{2} feedback controlling the movement parameters of the machine tool and the parameters of the power supply according to the pulse discharge parameters, controlling the discharge current and the discharge voltage, and calculating the number of rotations of the grinding wheel; \textcircled{3} determining the maximum truncating area of the cutting edge and the maximum effective number of rotations of the grinding wheel according to the grinding wheel parameters and the pulse discharge parameters, and precisely controlling the truncating area of the cutting edge of abrasive grains online by the calculated number of rotations of the grinding wheel; and \textcircled{4} after the calculated number of rotations of the grinding wheel reaches the target value, calculating the truncating area of the cutting edge and the protrusion height that truncate the microscale abrasive grains, and stopping the machine tool. The present invention can precisely control the truncating effect of the microscale abrasive grains only through the number of rotations of the grinding wheel and other parameters fed back by the in-position truncating system to, and can obtain different truncating areas of the cutting edge to meet different machining quality requirements.

1. An online precise control method for truncating parameters of microscale abrasive grains, wherein the method comprises the following steps:
step 1, clamping an electrode and a diamond grinding wheel to be truncated on a numerical control machine tool, connecting the diamond grinding wheel, the electrode, a power supply, a voltage sensor, a current sensor and a data collection card in a positive electrode manner to form a discharge circuit, and communicating, by a workstation, with the a power supply and a controller of the numerical control machine tool;
step 2. during in-position truncating, setting grinding wheel parameters and a target value of a number of rotations of the grinding wheel and planning a grinding wheel path, respectively feedback controlling movement parameters of the machine tool and parameters of the power supply through a machine tool-PC online monitoring software and a power supply-PC online monitoring software according to collected pulse discharge parameters, controlling a discharge current and a discharge voltage in a range of 3 A to 6 A and in a range that is 2 V to 5 V lower than an open circuit voltage of the power supply respectively, and calculating the number of rotations of the grinding wheel by the movement parameters of the machine tool;
step 3. selecting a maximum truncating area of a cutting edge and a maximum effective number of rotations of the grinding wheel thereof under the corresponding grinding wheel parameters, the corresponding pulse discharge parameters and the corresponding movement parameters of the machine tool from an expert database, and precisely controlling a truncating area of the cutting edge of truncating microscale abrasive grains online by the calculated number of rotations of the grinding wheel; and
step 4. comparing the calculated number of rotations of the grinding wheel with a set target value, after the calculated number of rotations of the grinding wheel reaches the target value, calculating the truncating area of the cutting edge and an protrusion height of the truncating microscale abrasive grains by the number of rotations of the grinding wheel, the pulse discharge parameters and the movement parameters of the machine tool, and meanwhile, sending a stop command, by the workstation, to the machine tool-PC online monitoring software to stop the machine tool.

2. The online precise control method for the truncating parameters of the microscale abrasive grains according to claim 1, wherein in step 2, a method to feedback control the movement parameters of the machine tool and the parameters of the power supply is as follows: adjusting at least one of a rotation speed of the grinding wheel and a feeding speed of the workstation first, then adjusting a current limiting value, and adjusting the open circuit voltage again; if control requirements are still unable to be met, adjusting a cutting depth and re-planning the grinding wheel path finally.

3. The online precise control method for the truncating parameters of the microscale abrasive grains according to claim 2, wherein in a stage of adjusting at least one of the movement parameters of the machine tool and the parameters of the power supply: when at least one of the discharge current is less than 3 A and the discharge voltage is 5 V lower than the open circuit voltage of the power supply, at least one of the rotation speed of the grinding wheel and the current limiting value are increased, and at least one of the feeding speed of the workstation or/and the open circuit voltage and the cutting depth are decreased; and when at least one of the discharge current is greater than 6 A and the discharge voltage is 2 V greater than the open circuit voltage of the power supply, at least one of the rotation speed of the grinding wheel and the current limiting value are decreased, and at least one of the feeding speed of the workstation, the open circuit voltage and the cutting depth are increased.

4. The online precise control method for the truncating parameters of the microscale abrasive grains according to claim 2, wherein the rotation speed of the grinding wheel ranges from 1500 rpm to 3000 rpm, the feeding speed of the workstation ranges from 20 mm/min to 200 mm/min, the cutting depth ranges from 1 μm to 3 μm, the open circuit voltage ranges from 15 V to 30 V, and the current limiting value ranges from 0.1 A to 2 A.

5. The online precise control method for the truncating parameters of the microscale abrasive grains according to claim 1, wherein in step 2, the target value is determined by machining quality grades in the expert database according to actual use requirements of a workpiece.

6. The online precise control method for the truncating parameters of the microscale abrasive grains according to claim 1, wherein the machine tool-PC online monitoring software and the power supply-PC online monitoring software comprise manual control and remote control functions, wherein a manner to read and transmit data of the remote control function is to read and transmit data in real time or in every 1 minute to 5 minutes.

7. The online precise control method for the truncating parameters of the microscale abrasive grains according to claim 6, wherein the machine tool-PC online monitoring software comprises functions of adjusting a spindle magnification and a feeding magnification, separating the grinding wheel and the electrode and respectively decelerating the same to zero when reading the stop command; and the power supply-PC online monitoring software comprises functions of adjusting the open circuit voltage, the current limiting value, a duty ratio and a frequency.

8. The online precise control method for the truncating parameters of the microscale abrasive grains according to claim 1, wherein the power supply is a direct current power supply, the electrode is an iron-based electrode, the voltage sensor and the current sensor are a high-frequency response voltage sensor and a high-frequency response current sensor respectively, and a grain size of the diamond grinding wheel ranges from #24 to #240.

9. The online precise control method for the truncating parameters of the microscale abrasive grains according to claim 1, wherein in step 4, the calculating the truncating area of the cutting edge and the protrusion height of the truncating microscale abrasive grains by the number of rotations of the grinding wheel, the pulse discharge parameters and the movement parameters of the machine tool comprises the steps:
calculating the protrusion height H_{c} of the truncating microscale abrasive grains;
$${H}_{c} = a {U}_{c}^{b} {I}_{c}^{c} + d ( 1 + \frac{{v}_{f}}{π D N} ) {( {D}^{3} {a}_{p} )}^{3 / 10} \qquad [ [ ( 1 ) ] ]$$
wherein a, b and c are coefficients related to the parameters of the power supply and electrode materials, and U_{c} is the discharge voltage; I_{c} is the discharge current, d is a coefficient related to a cutting chip length, D is a diameter of the grinding wheel, Nis the rotation speed of the grinding wheel, v_{f} is a feeding speed of the workstation, and aₚ is the cutting depth; and
calculating the truncating area s_{c}^{(k)} of the cutting edge of the truncating microscale abrasive grains:
$${s}_{c}^{( k )} = ( \sqrt{{s}_{c max}} - \sqrt{{s}_{c t}} ) \sqrt[3]{\frac{{n}_{max} \sqrt{{s}_{c t}} + k ( \sqrt{{s}_{c max}} - \sqrt{{s}_{c t}} ) ( {s}_{c t} + {s}_{c max} + \sqrt{{s}_{c max} {s}_{c t}} )}{{n}_{max} [ \sqrt{{s}_{c t}} + ( \sqrt{{s}_{c max}} - \sqrt{{s}_{c t}} ) ( {s}_{c t} + {s}_{c max} + \sqrt{{s}_{c max} {s}_{c t}} ) ]}}$$
wherein s_{cmax} is the maximum truncating area of the cutting edge, nₘₐₓ is the maximum effective number of rotations of the grinding wheel, k is the calculated number of rotations of the grinding wheel during in-position truncating, s_{ct} is the area of the cutting edge of the microscale abrasive grains before truncating; and in an initial state, s_{ct}≤1000 μm².

10. The online precise control method for the truncating parameters of the microscale abrasive grains according to claim 2, wherein the machine tool-PC online monitoring software and the power supply-PC online monitoring software comprise manual control and remote control functions, wherein a manner to read and transmit data of the remote control function is to read and transmit data in real time or in every 1 minute to 5 minutes.

11. The online precise control method for the truncating parameters of the microscale abrasive grains according to claim 3, wherein the machine tool-PC online monitoring software and the power supply-PC online monitoring software comprise manual control and remote control functions, wherein a manner to read and transmit data of the remote control function is to read and transmit data in real time or in every 1 minute to 5 minutes.

12. The online precise control method for the truncating parameters of the microscale abrasive grains according to claim 4, wherein the machine tool-PC online monitoring software and the power supply-PC online monitoring software comprise manual control and remote control functions, wherein a manner to read and transmit data of the remote control function is to read and transmit data in real time or in every 1 minute to 5 minutes.

13. The online precise control method for the truncating parameters of the microscale abrasive grains according to claim 5, wherein the machine tool-PC online monitoring software and the power supply-PC online monitoring software comprise manual control and remote control functions, wherein a manner to read and transmit data of the remote control function is to read and transmit data in real time or in every 1 minute to 5 minutes.

14. The online precise control method for the truncating parameters of the microscale abrasive grains according to claim 10, wherein the machine tool-PC online monitoring software comprises functions of adjusting a spindle magnification and a feeding magnification, separating the grinding wheel and the electrode and respectively decelerating the same to zero when reading the stop command; and the power supply-PC online monitoring software comprises functions of adjusting the open circuit voltage, the current limiting value, a duty ratio and a frequency.

15. The online precise control method for the truncating parameters of the microscale abrasive grains according to claim 11, wherein the machine tool-PC online monitoring software comprises functions of adjusting a spindle magnification and a feeding magnification, separating the grinding wheel and the electrode and respectively decelerating the same to zero when reading the stop command; and the power supply-PC online monitoring software comprises functions of adjusting the open circuit voltage, the current limiting value, a duty ratio and a frequency.

16. The online precise control method for the truncating parameters of the microscale abrasive grains according to claim 12, wherein the machine tool-PC online monitoring software comprises functions of adjusting a spindle magnification and a feeding magnification, separating the grinding wheel and the electrode and respectively decelerating the same to zero when reading the stop command; and the power supply-PC online monitoring software comprises functions of adjusting the open circuit voltage, the current limiting value, a duty ratio and a frequency.

17. The online precise control method for the truncating parameters of the microscale abrasive grains according to claim 13, wherein the machine tool-PC online monitoring software comprises functions of adjusting a spindle magnification and a feeding magnification, separating the grinding wheel and the electrode and respectively decelerating the same to zero when reading the stop command; and the power supply-PC online monitoring software comprises functions of adjusting the open circuit voltage, the current limiting value, a duty ratio and a frequency.
